(19) United States
(12) Patent Application Publication
(10) Pub. No.: US 2025/0305561 A1
(43) Pub. Date: Oct. 2, 2025

(54) DRIVE MODULE FOR A CYCLOID DRIVE, AND DIRECTLY DRIVEN CYCLOID DISC

(71) Applicant: KUKA Deutschland GmbH, Augsburg (DE)

(72) Inventor: Andreas Keibel, Augsburg (DE)

(73) Assignee: KUKA Deutschland GmbH, Augsburg (DE)

(21) Appl. No.: 18/864,601

(22) PCT Filed: May 26, 2023
(86) PCT No.: PCT/EP2023/064146

§ 371 Date: Nov. 11, 2024

(30) Foreign Application Priority Data
May 30, 2022 (DE) 10 2022 205 379.6

(51) Int. Cl. F16H 1/32; H02K 41/06

(52) U.S. Cl. CPC F16H 1/321; H02K 41/065

(57) ABSTRACT

A drive module for a cycloid drive includes a cycloid disc that can wobble eccentrically about a central axis and has a cycloid profile on the edge of the cycloid disc, the profile being in engagement with an outer support at a location. The cycloid disc further includes a central opening, at least three bearing holes, and an inner support comprising at least three webs, wherein the bearing holes receive the webs and couple the cycloid disc to the inner support. A direct drive is designed to act magnetically on the cycloid disc such that the cycloid disc interacts with a magnetic field of the direct drive and is brought into a wobbling motion in a translational manner via the magnetic field, wherein the output process of the drive module is carried out via the outer or inner support.

### CROSS-REFERENCE TO RELATED APPLICATIONS

This application is a national phase application under 35 U.S.C. § 371 of International Patent Application No. PCT/EP2023/064146, filed May 26, 2023 (pending), which claims the benefit of priority to German Patent Application No. DE 10 2022 205 379.6, filed May 30, 2022, the disclosures of which are incorporated by reference herein in their entirety.

### TECHNICAL FIELD

The present invention relates to a drive module for a cycloid drive and to a cycloid drive, in particular for a multi-axis machine and/or a robot.

### BACKGROUND

Cycloid drives, also known as cycloid gears or eccentric gears, typically comprise an eccentric disc or eccentric with which a cycloid disc is moved. The eccentric disc is usually rotated via a shaft by an external motor or drive. Cycloid drives are usually used to achieve lower speeds compared to the drive in order to be able to provide high torques at the output, and are therefore used where, usually, low speeds but high torques are to be transmitted. The advantage of cycloid drives is that they can be subjected to a shock load of several times the nominal torque and their small(er) installation space can be advantageous compared to other types of gears.

Common cycloid drives comprise a cycloid disc or wobble plate which can wobble eccentrically about a central axis but cannot rotate freely. A point on the disc follows a small circular path, compared to its diameter, without self-rotation. This wobble plate, with its external toothing, which is profiled in a wave-like manner, for example, is in engagement with an internal toothing of an outer ring, which is designed to fit inversely in a precise manner, wherein the cycloid disc usually comprises fewer teeth, in particular wave crests, than there are teeth, in particular rounded pins, on the outer ring. In order to prevent the cycloid disc from self-rotating as a result of the engagement with the external toothing, it is provided with N holes on a radius inside the disc, into which holes pins or webs of smaller diameter protrude, which are installed on a support ring, i.e., the cycloid disc is mounted in a wobbling manner about these pins or webs relative to the support ring in their common plane, wherein the support ring remains in the central axis.

### SUMMARY

The object of the present invention is to improve a drive module for a cycloid drive, in particular a cycloid drive, in particular to make this drive module (more) compact, and in particular without a rotating shaft which has to rotate faster than the output with the transmission ratio of the drive module.

This object is achieved by a drive module, a method, and a system or a computer program or computer program product for carrying out a method as described herein.

According to one embodiment of the present disclosure, a drive module, in particular for a cycloid drive, comprises a cycloid disc, also known as a cam disc or wobble plate. In one embodiment, the cycloid disc comprises a cycloid profile that meshes with an outer support. Furthermore, in one embodiment, the cycloid disc comprises a central opening, in particular an opening which is formed concentrically with the cycloid disc. In one embodiment, the cycloid disc comprises at least two bearing holes, in particular bearing holes which are arranged on a circular path concentric with the cycloid disc, in particular a circle concentric with the cycloid disc. In one embodiment, the bearing holes are evenly distributed, in particular over the circle, or at least substantially equally spaced from one another.

According to one embodiment of the present disclosure, the drive module comprises an inner support comprising at least three webs, wherein the webs are designed such that they are or can be received by the bearing holes and allow a rotation-like movement required for the cycloid movement of the cycloid disc. In particular, the bearing holes and the webs are designed in such a way that the cycloid disc with the bearing holes and the webs can or does perform a cycloid or wobbling movement. In an embodiment with the bearing holes, the cycloid disc is coupled to the inner support via the webs or can be coupled to it via the webs.

According to one embodiment of the present disclosure, the drive module comprises a direct drive, wherein the direct drive is designed to act magnetically on the cycloid disc. In one embodiment, the cycloid disc interacts with the magnetic field of the direct drive and is deflected or rotated, in particular eccentrically, via this interaction. In one embodiment, at least one part, in particular the (primarily) inner part through which the magnetic flux passes, of the cycloid disc consists of a, preferably particularly, suitable magnetic material.

Advantageously, the drive module, in particular the combination of drive and cycloid gear, can hereby be built significantly (more) compactly, in particular the required installation space can be reduced or made smaller, wherein in one embodiment the masses and/or mass inertias are advantageously reduced.

According to one embodiment, the direct drive comprises a pole shoe ring comprising pole shoes, wherein the pole shoe ring is arranged in the opening of the cycloid disc, in particular on a central axis of the drive module. In one embodiment, the pole shoe ring forms an air gap with the opening of the cycloid disc, so that in particular an eccentric movement of the cycloid disc about the central axis is enabled or possible. According to one embodiment, the pole shoes are aligned radially outwards in the direction of the cycloid disc. The term “radially” is preferably understood here as perpendicular to the central axis.

According to one embodiment, the direct drive comprises a pole shoe ring comprising pole shoe pairs, which form a north pole and a south pole, in particular in the axial direction. In one embodiment, this makes it possible to enhance the effect of the direct drive.

According to one embodiment, the direct drive comprises a pole shoe ring comprising pole shoes, wherein the pole shoe ring is arranged outside the cycloid disc, in particular (radially) outside the outer support. In a development, the direct drive comprises a pole shoe ring in (inside) the opening of the cycloid disc and a pole shoe ring (radially) outside the cycloid disc, in particular (radially) outside the outer support. In one embodiment, the pole shoe ring comprises at least 6, in particular at least 10 or at least 20, and/or at most 200 pole shoes, in particular at most 120 or at most 60.

According to one embodiment, the pole shoe ring comprises a central opening, in particular a passage, in particular a rigid central opening or passage. This can be designed in one embodiment as a hollow shaft which is formed through the assembly of the drive module, in particular through the entire assembly, in particular without impairing the function of the drive module. In one embodiment, the central opening is arranged coaxially with the pole shoe ring; in particular, in one embodiment, the center of the opening is on the central axis.

In one embodiment, this advantageously makes it possible for cabling to be laid or able to be laid through the drive module, in particular through the central opening or passage. Furthermore, in one embodiment, this can enable a design with fewer disruptive contours and/or a more aesthetic design, in particular because components and/or cabling do not have to be relocated to the outside through the opening or passage, in particular in the case of multi-axis machines and/or robots with sequential axes in particular, but can be accommodated in the opening or passage and/or passed through it in a (more) aesthetic manner. Shifting masses “inwards” makes it possible to realize low(er) moments of inertia in one embodiment. Especially in the field of collaborative robots, also known as cobots, a (more) aesthetic appearance or design is advantageous for a (more) direct interaction between a user and the robot. In one embodiment, this can make it possible for the surfaces of the robot, which is equipped with or comprises a drive module described herein, to be designed to be smooth(er) surfaces, in particular without bulges, in particular if the drive module is used in a cobot. “Robots” and examples involving robots are to be understood herein without restriction of generality.

According to one embodiment, the drive module does not comprise an eccentric; in particular the cycloid disc of the drive module is not moved via an eccentric or an eccentric disc. Advantageously, this allows the drive module to be constructed in a (more) simple, in particular (more) compact, embodiment.

According to one embodiment, the drive module comprises no permanent magnets, in particular the actuation comprises no permanent magnets, so that it is based in particular on reluctance. This makes it possible to build a (more) cost-effective, in particular (more) material-saving, drive module in one embodiment, in particular without the use of rare earth magnets. Furthermore, in one embodiment, weight can be saved, in particular by eliminating the need for (relatively heavy) permanent magnets. By eliminating permanent magnets, in one embodiment there is advantageously no counter EMF (electromotive force), which would in particular result in a maximum speed dependent on the operating voltage. In one embodiment, the direct drive is (thus) a synchronous reluctance motor.

Furthermore, according to one embodiment, the electromagnets of the direct drive are fixed, in particular with respect to a casing of the drive module. Advantageously, according to one embodiment, the moment of inertia is small(er), in particular it is determined (only) by the center of mass circling around the wobble radius (as a pure translational amount of its mass, in particular not as a moment of inertia during rotation) of the cycloid disc and a load at the output. In one embodiment, this makes it possible for the drive module to comprise a, in particular very (much), low(er) moment of inertia, in particular in comparison to a drive module that is actuated by an electric motor via an eccentric.

According to one embodiment, the drive module comprises means for determining a position, in particular at least one sensor, in particular at least one sensor for determining a position of the cycloid disc and/or the output. In one embodiment, the at least one sensor is a Hall sensor, two xy sensors, a rotatable web comprising a position or rotation sensor and/or the like. In this way, a (more) accurate, in particular (more) precise, positioning of the drive module can advantageously be achieved, in particular carried out, in particular in combination with a controller or means for controlling (actuating) the electromagnets. In one embodiment, a drive module can hereby advantageously be used in a preferably shock-load-resistant actuator for a multi-axis machine, in particular a robot.

According to one embodiment, the cycloid disc comprises an extension, in particular a projection, which is formed in a ring-like manner on the radially inner side of the cycloid disc. In one embodiment, the extension can be embodied in one piece with the cycloid disc or, in one embodiment, it can be formed in two or more parts, in particular it can be connected to the cycloid disc by a form-fitting, frictionally engaged and/or integrally bonded connection. Furthermore, in a development, the extension is formed in one piece or in multiple pieces, in particular in a ring-like manner, further in particular in a ring-segment-like manner. In one embodiment, the pole shoes of the pole shoe ring are bipolar and in particular comprise a magnetic north pole and a magnetic south pole, in particular when the electromagnets are activated. In one embodiment, a pole shoe is divided into two parts, in particular configured such that it forms a north pole and a south pole at a radial end in the direction of the central axis; in particular, the pole shoe ring comprises pole shoe pairs which are arranged in pairs such that a first pole shoe and a second pole shoe of the pole shoe pair are arranged next to one another in the axial direction (in the direction of the central axis). In one embodiment, the extension is configured such that it fits into an existing gap between the pole shoe pairs or the plurality of pole shoes, in particular in an embodiment with pole shoe pairs or a plurality of pole shoes arranged in the axial direction. In one embodiment, this advantageously makes it possible for the effect of the electromagnets, in particular that of reluctance minimization, to be greater than in particular without an extension.

According to one embodiment, the cycloid disc comprises more than one extension, in particular at least two extensions. Accordingly, in one embodiment, the pole shoe ring comprises a plurality of pole shoes in the axial direction, which are arranged alternately with the at least two extensions or in pairs between the at least two extensions. Advantageously, this can make it possible in one embodiment for the effect on the cycloid disc to be increased by the extension(s), in particular in comparison with a cycloid disc comprising only one extension, or only one (radially) inner or only one (radially) outer pole shoe ring.

In one embodiment, the extension of the cycloid disc can enclose the pole shoe at least substantially on both sides. In other words, the extension can be designed in one embodiment such that the pole shoe is enclosed at least substantially on both sides. Advantageously, in one embodiment, this can make it possible for the effect of the interaction between the cycloid disc and the magnetic field to be enhanced or to be greater than it would be without an extension.

In one embodiment, the drive module comprises at least one, in particular at least two or at least three, and/or at most five cycloid discs. In one embodiment, each of the existing cycloid discs comprises a direct drive, in particular a pole shoe ring. In a development, the cycloid discs are arranged in such a way that an overall center of gravity of the present cycloid discs is or remains stationary during a wobbling movement. In one embodiment, the phase of the cycloid discs is shifted relative to one another by 180°, in particular in the case of two cycloid discs, or by 120°, in particular in the case of three cycloid discs. In one embodiment, the phase shift is 360°/N, wherein N is the number of cycloid discs present. Advantageously, this can make it possible in one embodiment for the drive module to be low-vibration/lower-vibration than in particular one or more cycloid discs which comprise a center of mass of the cycloid discs which moves during the wobbling movement of the cycloid disc(s), in particular is not stationary.

In one embodiment, the provided, in particular the at least two or at least three, and/or at most five, cycloid discs have different thicknesses in the axial direction (in the direction of the central axis), in particular such that an overall center of mass of the cycloid discs lies on the central axis. Advantageously, this can make it possible in one embodiment for the drive module to be subject to less vibration.

According to one embodiment of the present disclosure, a cycloid drive comprises at least one drive module described herein. In an embodiment, as already described herein, this can reduce a moment of inertia of the drive, in particular enable strong or stronger robots and preferably contribute to an improvement in the aesthetics and/or the reduction of the disruptive contours of a robot. Advantageously, in accordance with one embodiment, the cycloid drive is designed to be small(er), in particular with fewer mechanically stressed parts or assemblies.

According to one embodiment of the present disclosure, a method for controlling a drive module for a cycloid drive, in particular a drive module described herein, is provided. In one embodiment, the method comprises determining a position of the cycloid disc. Alternatively or additionally, the method comprises determining the position of an output of the drive module. Furthermore, in one embodiment, the method comprises actuating, in particular commutating, the at least one electromagnet of at least one of the pole shoes, in particular actuating at least three electromagnets of at least three pole shoes, in particular such that the cycloid disc of the drive module is positioned and/or moved based on the determined position of the cycloid disc and/or the determined position of the output. In one embodiment, the actuation of the electromagnets or their commutation is carried out in particular only on the basis of a position if this has been determined; otherwise the actuation is carried out on the basis of the position that has been determined. The term “determined” as used herein should preferably be understood as “insofar as determined”. In one embodiment, the actuation causes the cycloid disc to adjust an air gap in such a way that a “wobbling” or “swaying” movement of the cycloid disc about the central axis is induced, in particular by the actuation. Advantageously, this makes it possible in one embodiment for the cycloid disc to be precisely positioned and/or moved and or to be capable of same. This allows a (more) precise actuation of the drive module in one embodiment, in particular in comparison with an eccentric-controlled drive module.

Furthermore, in one embodiment of the present disclosure, a system is provided for operating and/or monitoring a drive module for a cycloid drive, in particular a cycloid drive for a multi-axis machine, which system is configured to carry out a method, as described in particular herein. In one embodiment, the system is configured to operate and/or monitor multiple drive modules. In one embodiment, the system comprises means for determining a position, in particular of the cycloid disc and/or the output of the drive module. Furthermore, in one embodiment, the system comprises means for actuating the at least one electromagnet, in particular means for actuating at least three electromagnets, in particular for deflecting the cycloid disc, further in particular for inducing a wobbling movement of the cycloid disc about the central axis.

Advantageously, this can make it possible in one embodiment for the system to be actuated (more) accurately and/or precisely, in particular to be moved or movable, in particular by means of the drive module.

A system and/or a means in the sense of the present disclosure may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to issue output signals to a data bus. A memory system may comprise one or more, in particular different, storage media, in particular optical, magnetic, solid-state, and/or other non-volatile media. The program may be designed in such a way that it embodies or is capable of carrying out the methods described herein, so that the processing unit is able to carry out the steps of such methods and thus, in particular, is able to operate or monitor the machine.

In one embodiment, a computer program product may comprise, in particular be, an, in particular computer-readable and/or non-volatile, storage medium for storing a program or instructions or with a program stored thereon or with instructions stored thereon. In one embodiment, execution of said program or said instructions by a system or controller, in particular a computer or an arrangement of multiple computers, causes the system or controller, in particular the computer(s), to carry out a method described herein or one or more steps thereof, or the program or instructions are configured to do so.

In one embodiment, one or more, in particular all, steps of the method are implemented completely or partially automatically, in particular by the controller or its means.

In one embodiment, the system comprises a multi-axis machine, in particular a robot.

Embodiments of the invention described herein may be combined (inventively) wherever this is technically reasonable and feasible.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a drive module, in a plan view, comprising a cycloid disc with internal electromagnets for their direct drive according to the synchronous reluctance motor principle according to an embodiment of the present disclosure;

FIGS. 2a and 2b show an extension of the cycloid disc according to embodiments of the present disclosure;

FIG. 3 shows a detail of a drive module in a sectional view according to embodiments of the present disclosure; and

FIG. 4 shows a method for controlling a drive module for a cycloid drive.

### DETAILED DESCRIPTION

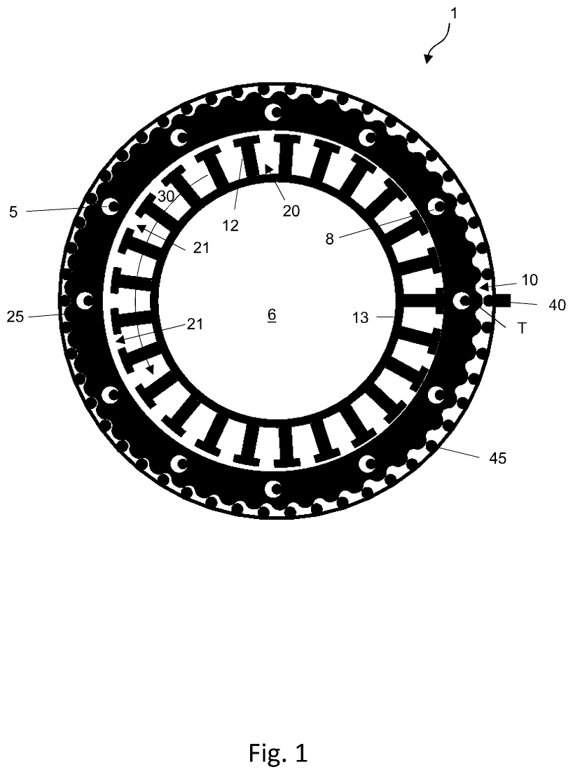

FIG. 1 shows a drive module 1 for a cycloid drive, in a plan view, comprising a cycloid disc 10. The cycloid disc 10 comprises bearing holes 5 which are evenly distributed on a circular path concentric with the opening 6 of the cycloid disc 10. Furthermore, an inner support comprising webs 8 is shown in FIG. 1, wherein the webs 8 are received in the bearing holes 5 in such a way that the cycloid disc 10 can execute a wobbling movement about the central axis or executes it upon activation of the electromagnets 20 (here only shown by means of the pole shoes 12). The pole shoes 12 are designed as a pole shoe ring 13. Furthermore, FIG. 1 schematically shows an output 40 via the outer support comprising output teeth 45. The wobbling motion T of the cycloid disc 10, which is triggered by (targeted) activation of the electromagnets and thereby forms a moving air gap 21 between the cycloid disc 10 and the pole shoe ring 13, leads to a rotation of the output 40, shown here as an example. The opening 6 offers the possibility of leading cables, in particular data cables and/or electrical supply lines, through the drive module 1. These then do not have to be guided over the outside of the machine or robot. The drive module, with its wobbling movement T of the cycloid disc 10, can alternatively be designed for an output via the inner support by the webs. This alternative is not shown in FIG. 1.

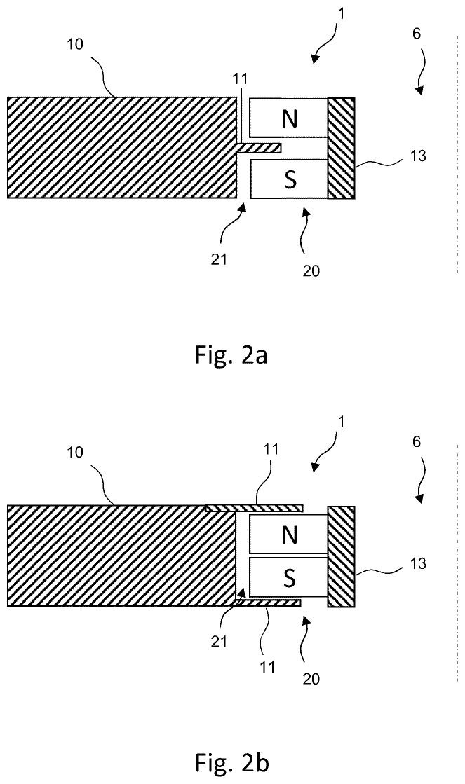

FIG. 2a shows a schematic section in the radial direction through a portion of the cycloid disc 10 comprising an extension 11. The extension 11 of the cycloid disc 10 points radially inwards from the cycloid disc 10, in the direction of the pole shoe ring 13. The pole shoe ring 13 comprises a pole shoe pair with pole shoes 12, which are shown here as an example with a north and a south pole. The extension 11 also sets an air gap 21 when an electromagnet 20 is activated. The air gap 21 shifts according to the wobbling motion T of the cycloid disc 10. The center of the opening 6 is shown schematically and not to scale by a dashed line (central axis).

In contrast to FIG. 2a, FIG. 2b schematically shows a cycloid disc 10 of a drive module 1 that comprises two extensions 11 that frame the pole shoes 12 of the pole shoe ring 13 in the axial direction. One of the extensions 11 is designed as a separate component and is connected to the cycloid disc 10. An air gap 21 changes, as described herein, depending on the activation of the electromagnets 20. The pole shoes 12 in FIG. 2b preferably comprise a north pole and a south pole. The electromagnets can also be configured differently, in particular according to an embodiment described herein.

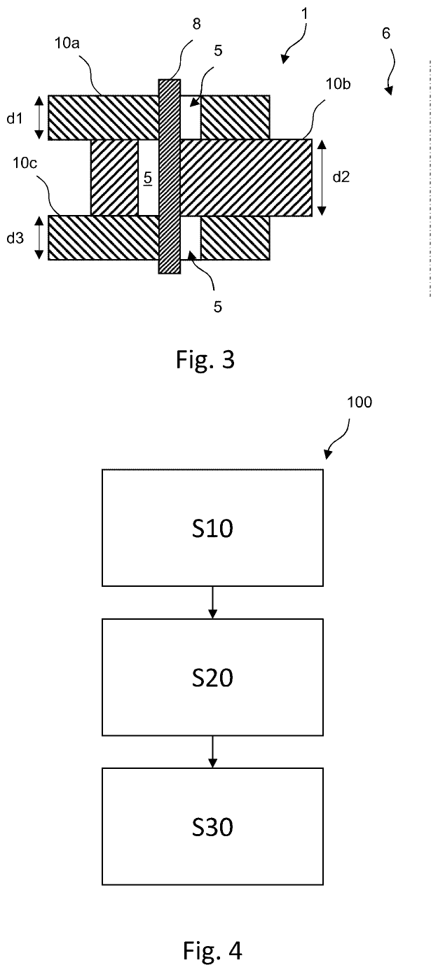

FIG. 3 shows a schematic sectional view through a detail of the drive module 1. In the embodiment of FIG. 3, the drive module 1 comprises a plurality of cycloid discs 10a, 10b, 10c, which have different thicknesses d1, d2, d3 in the axial direction. The cycloid discs 10a, 10b, 10c are arranged offset from one another in such a way that an overall center of gravity of the cycloid discs 10a, 10b, 10c is (at least substantially) stationary during a wobbling movement of the cycloid discs 10a, 10b, 10c. The center of the opening 6 is shown schematically and not to scale by a dashed line.

FIG. 4 schematically shows a method 100 which, in a first step S10, represents a determination of a position of the cycloid disc, in a second alternative or supplementary step S20 a determination of a position of the output of the drive module 1 and, in a third step S30, an actuation of an electromagnet based on a position after steps S10 and/or S20, insofar as these were determined.

Although exemplary embodiments have been explained in the preceding description, it is pointed out that a large number of modifications is possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### List of Reference Signs

1 Drive module
5 Bearing hole
6 Opening
8 Web
10 Cycloid disc
10a, 10b, 10c Cycloid discs
11 Extension
12 Pole shoe
13 Pole shoe ring
20 Electromagnet
21 Air gap
25 Cycloid profile
30 Surrounding magnetic field
40 Outer support
45 Output teeth
100 Method
T Wobbling motion of the cycloid disc about the webs
S10 Determining a position of the cycloid disc
S20 Determining a position of the output
S30 Actuating an electromagnet

What is claimed is:

1. Drive module (1) for a cycloid drive, comprising:
a cycloid disc (10), wherein the cycloid disc (10) can wobble eccentrically about a central axis and comprises
a cycloid profile (25) on the edge of the cycloid disc, said profile being in engagement with an outer support (40) at a location;
a central opening (6); and
at least three bearing holes (5),
an inner support comprising at least three webs (8), wherein the bearing holes (5) receive the at least three webs (8) and couple the cycloid disc (10) to the inner support; and
a direct drive which is designed to act magnetically on the cycloid disc (10) so that the cycloid disc (10) interacts with a magnetic field of the direct drive and is brought into a wobbling motion in a translational manner via the magnetic field, wherein an output process of the drive module (1) is carried out via the outer or the inner support.

2-13. (canceled)
